(19) United States
(12) Patent Application Publication
(10) Pub. No.: US 2020/0044716 A1
(43) Pub. Date: Feb. 6, 2020

(54) Channel Tracking in Beam Based Mobility, a Radio Receiver, and a Radio Transmitter

(71) Applicant: TELEFONAKTIEBOLAGET LM ERICSSON (PUBL), Stockholm (SE)

(72) Inventors: Osman Nuri Can Yilmaz, Espoo (FI); Antonino ORSINO, Masala (FI); Andres REIAL, Malmö (FI)

(21) Appl. No.: 15/738,653

(22) PCT Filed: Dec. 12, 2017
(86) PCT No.: PCT/EP2017/082377

§ 371 Date: Dec. 21, 2017

(51) Int. Cl. H04B 7/06; H04B 17/318; H04B 1/06; H04B 1/02; H04L 1/20

(52) U.S. Cl. CPC H04B 7/0632; H04B 17/318; H04L 1/20; H04B 1/06; H04B 1/02; H04B 7/0617

(57) ABSTRACT

The present disclosure relates to a radio receiver 10, 110, 120, 130, a radio transmitter 10, 110, 120, 130, a communication system 100, and methods thereof, and relates in particular to a method in a communication system 100 comprising at least a radio receiver 10, 110, 120, 130 and a radio transmitter 10, 110, 120, 130, the method comprising the steps of determining a derivative value of a metric; reporting the derivative value to the wireless communication system 100, and receiving a derivative value of a metric.

### TECHNICAL FIELD

The present disclosure relates to a radio receiver for communicating with a radio transmitter in a wireless communication system, the radio transmitter for communicating with the radio receiver in the wireless communication system, the communication system comprising the radio receiver and the radio transmitter, a method in the radio receiver, a method in the radio transmitter, a method in the communication system, a computer program, and a computer program product.

### BACKGROUND

Recently, there have been efforts to develop a wireless communication system employing high frequencies or even ultrahigh frequencies. In the framework of so called New Radio (NR) technology, which is an example of a Fifth Generation (5G) Cellular Network, it was discussed to employ ultrahigh frequencies, for instance, from 10 to 100 GHz or, in other words, ultra-short wavelengths, for instance, millimeter waves, e.g. mmW.

In this framework of ultrahigh frequencies, a signal power received at a receiver, for instance a radio device or a radio access node, may be sensitive to changes in its surroundings or environment. Note the radio device may also be called a wireless device whose communication may be carried cut over any air interface between the wireless device and the radio access node and may be referred to as an end user device or user equipment, UE, in the case of Third Partnership Project Program (3GPP) Fourth Generation (4G) and 5G Long Term Evolution, LTE, as well as 5G NR. In contrast, a radio access node may denote a network element that may form part of a radio access network serving the wireless device and which may communicate via a radio interface with the served wireless device.

It is expected that in future systems such as NR or 5G high frequencies in a range that goes from 10 GHz to 100 GHz are employed. When using high frequencies, one requirement for achieving a high antenna gain to ensure sufficient link budget may be that directive antennas are used, as for instance depicted in FIG. 1.

FIG. 1 illustrates the use of multiple directive beams 130-1 for a radio access node 130 and multiple directive beams 50-1 for a radio device 50. Accordingly, the radio access node 130 and the radio device 50 may be provided with multiple directive antennas, each employing a single beam or multiple beams. The directive beans 130-1 and 50-1 of the radio access node 130 and the radio device 50, respectively, may span around the radio access node 130 or over the cell coverage area, and the radio device 50, respectively, i.e. over 120°, 180°, or 360°.

With respect to FIG. 1, it may be considered when using high frequencies, i.e. from 10 GHz up to 100 GHz, that a received signal power may decrease drastically due to movements, i.e., rotation, translation, mobility, or atmospheric attenuation. With respect to the movement and mobility of a receiver or transmitter, one reason for a signal being lost, may be a change in a receiver or transmitter position or orientation causing an incorrect beam synchronization between the receiver, RX, and the transmitter, TX. When such a situation occurs, a beam tracking operation may need to be performed by for instance sweeping a TX and RX beam orientation, thus maintaining a correct beam alignment.

For instance, the received signal power may decrease significantly due to a movement (like rotation or translation) of the receiver due to obstacles in-between the receiver and a transmitter, and/or due to long distances between transmitter and receiver or atmospheric changes. In this context, it is noted that the transmitter may be the radio device or the radio access node, and the receiver may be the respective other one.

Accordingly, the received signal power may be reduced due to insufficient spatial alignment between the receiver and the transmitter. In this case the alignment between the receiver and the transmitter may need to be established or re-established. In the case in which directive beams are used by the transmitter and/or the receiver, a synchronization process such as beam alignment or beam re-alignment, beam tracking, and/or beam refinement may need to be performed.

For synchronization of beam directions for transmission and reception a legacy solution based on an exhaustive search method, defined in the IEEE 802.11ad standard, can be used. In this method, the transmitter, TX, and the receiver, RX, both have to scan a large space to find an alignment that is suitable for the transmitter and receiver beams. In other words, this procedure may have to be applied on the TX as well as RX side in order to find the most suitable beam directions of transmission and reception.

For instance, as shown in FIG. 2, once a connection between the receiver and the transmitter is established, the link quality degradation due to user movements or rotations may be handled for instance through beam refinement procedures that may search around the previous beam pair in order to achieve a new combination of beams, i.e. between the TX and RX, that is able to guarantee a suitable channel quality.

In a first step S11 of this procedure, beam tracking is performed to align the TX and RX beams. This step may be performed by the TX and the RX. Note, both the radio access node and the radio device can correspond to the the RX and TX. In a nest step S12, the TX or the RX, respectively, reports network measurements, e.g. Signal to Interference and Noise Ratio (SINR), Channel Quality Indicator (CQI) or Received Signal Received Power (RSRP). In a next step S13, it is determined whether the TX and RX beams are aligned based on the reported parameter. If the determination is in the affirmative, the transmission continues in a step S14. In the determination is not in the affirmative, the method loops back to step S11.

In case moderate degradation of the received power signal occurs after establishing the connection between the transmitter and the receiver, for instance due to movement of the transmitter, a procedure such as beam refinement may be performed, wherein the search is carried out around a previous sector pair defined by the receiver beam and transmitter beam, such that a new set of beams for the receiver and the transmitter is identified for maintaining a high received signal power, and thus a high channel quality.

Accordingly, for instance in case a wireless communication system employs a high frequency signal and directive beams, i.e. directive antennas, procedures such as beam alignment, beam refinement and beam tracking may be necessary. Therefore, messaging regarding all or a great number of beams of the transmitter and the receiver have to be exchanged between the transmitter and the receiver until a suitable alignment is reached, resulting in a long training time and use of a large amount of network resources.

Such an alignment procedure may be particularly complex and elaborate in the case of ultrahigh frequencies, i.e. millimeter wave propagation, as small movements may lead to a significant change in the received power at the receiver and may lead to the need for frequent synchronization due to misalignment.

One may consider a beam management procedure in which a transmitter acting as a reporting reception point determines a rate of change based on reports such as quality metric reports received from a receiver.

However, in such a case, necessary filtering at the radio device side before the reporting may filter also information regarding any derivative information such as the rate of change. Further, determining the derivative value from consecutive filtered absolute measurements may cause the effective filter time constant to be doubled in time, making an accurate dynamic tracking of rapid variations difficult. In case the derivative information is determined using consecutive reports from the receiver, at least two reports are necessary in order to determine the derivative information, in other words, there is a waiting period until the second report arrives resulting in a further delay. This may be particularly problematic, if beam management is time sensitive and needs to be carried out quickly, as in the case of employing ultrahigh frequencies.

Further, the metric reported by the receiver may change rapidly over beam coverage areas, resulting in a limited usability of consecutively reported metrics in order to determine derivative information.

According to these described synchronization procedures, the synchronization may not be adequately performed in a system that requires frequent beam alignment or refinement.

There may be the need for a method and system allowing rapid and frequent synchronization between a receiver and a transmitter.

### SUMMARY

The above-mentioned problems and drawbacks of the conventional methods are solved by the subject matter of the independent claims. Further preferred embodiments are described in the dependent claims.

According to a first aspect of the present disclosure there is provided a radio receiver for communicating with a radio transmitter in a wireless communication system. The radio receiver is adapted to determine a derivative value of a metric, and report the derivative value.

According to a second aspect of the present disclosure there is provided a radio transmitter for communicating with a radio receiver in a wireless communication system. The radio transmitter is adapted to receive a derivative value of a metric.

According to a third aspect of the present disclosure there is provided a communication system comprising the radio receiver according to the first aspect and the radio transmitter according to the second aspect.

According to a fourth aspect of the present disclosure there is provided a method in a radio receiver for communicating with a radio transmitter in a wireless communication system. The method comprises the steps of determining a derivative value of a metric and reporting the derivative value.

According to a fifth aspect of the present disclosure there is provided a method in a radio transmitter for communicating with a radio receiver. The method comprises the step of receiving a derivative value of a metric.

According to a sixth aspect of the present disclosure there is provided a method in a communication system comprising at least a radio receiver and a radio transmitter. The method comprises the steps of determining a derivative value of a metric, reporting the derivative value to the wireless communication system, and receiving a derivative value of a metric.

According to a seventh aspect of the present disclosure a computer program is provided that comprises code. The code, when executed on processing resources, instructs the processing resources to perform a method according to one or the fourth to sixth aspects.

According to an eight aspect of the present disclosure a computer program product is provided that stores a code. The code, when executed on processing resources, instructs the processing resources to perform a method according to any of the fourth to sixth aspects.

### BRIEF DESCRIPTION OF THE DRAWINGS

Embodiments of the present disclosure, which are presented for better understanding the inventive concepts but which are not to be seen as limiting the present disclosure, will now be described with reference to the figures in which:

FIG. 1 shows a radio receiver and radio transmitter, both using directive beams;

FIG. 2 shows a procedure for beam tracking for a receiver and a transmitter, both shown in FIG. 1;

FIG. 3 shows a schematic overview of a network environment, in which methods according to embodiments are performed;

FIG. 4 shows a radio device adapted to perform a method according to an embodiment of the present disclosure;

FIG. 5 shows a radio access node according to an embodiment of the present disclosure;

FIG. 6 shows a flowchart of a method according to an embodiment of the present disclosure;

FIG. 7 shows an embodiment for filtering and beam tracking or refinement; and

FIG. 8 shows a graph for a metric measured by a receiver shown in FIG. 4 over time;

FIG. 9 shows a graph for derivative information determined from the metric shown in FIG. 8;

FIG. 10 shows a flowchart of a method according to another embodiment of the present invention.

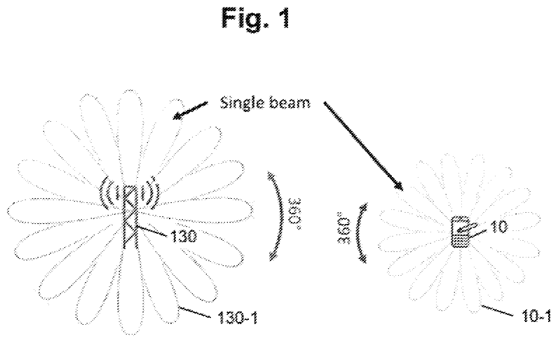

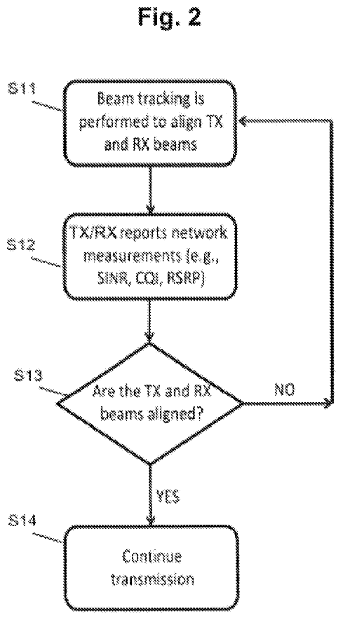

### DETAILED DESCRIPTION OF PREFERRED EMBODIMENTS

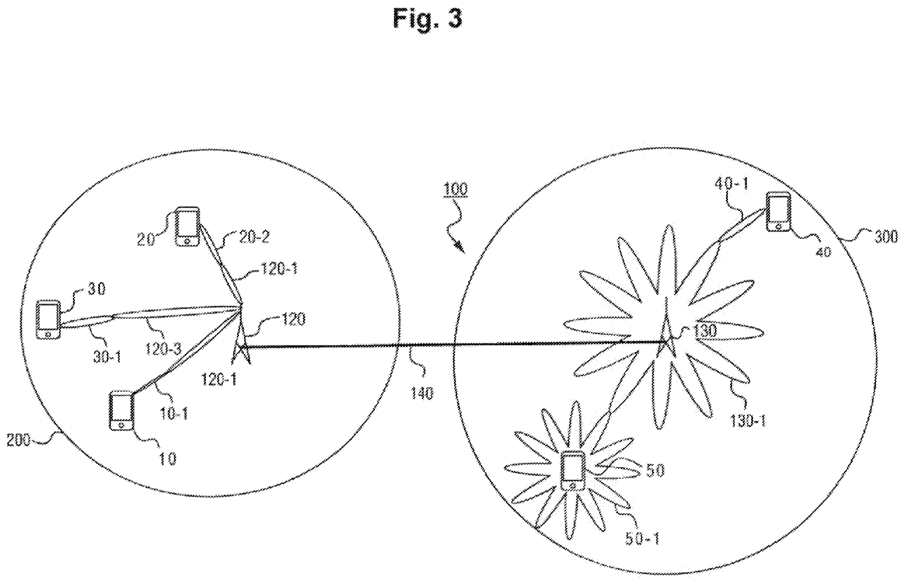

FIG. 3 shows a schematic overview of an exemplary network environment. A communication network 100, includes a number of network elements such as radio access nodes 120, 130. The network 100 may enable provision of a network service to a plurality of radio devices 10-50. Such services may include, telephony, video-telephony, chatting, internet browsing, email access, and the like. For this purpose, the radio access nodes 120, 130 may send data to and receive data from a plurality of radio devices 10-50, respectively. The communication between the radio access nodes 120, 130 can be wireless and/or wired and may for instance be implemented by an interface 140 such as an X2 interface. The radio access nodes 120, 130 can be embodied for example as 4G eNodeBs, 5G eNodeBs, or 5G NR gNodeBs.

The radio access nodes 120, 130 may communicate with the individual radio devices 10-50 via a radio interface and may employ radio links for transmitting and receiving data to and from a radio device 10-50, respectively.

The radio access nodes 120, 130 and the radio devices 10-50 may use a directive beam for communication as the radio devices 10, 20, 30, 40 and node 120. It may also be conceivable that omni-directional cells for instance deployed in high frequency are used as by the radio device 50 or the node 130. In the case of omni-directional cells, the radio device 50 may experience a similar phenomenon.

Although not depicted in the figure the network 100 may further include a packet gateway, a controlling node, a server, or a resource in a data center.

In cellular networks, there may be a plurality of cells 200, 300, formed by the respective serving radio access node 120, 130. Each of these nodes 120, 130 may transmit a signal, i.e. a reference signal, which signal may identify the cell 200, 300.

However, the present disclosure is not limited to either high frequencies or to highly directive antennas, and other environments such as low-band deployments using e.g. high-order sectorization, i.e. effectively selecting one of relatively wide beams, may be conceivable where a rapid and frequent synchronization between receiver and transmitter may be necessary.

According to one embodiment there is provided a radio receiver for communicating with a radio transmitter in a wireless communication system. The radio receiver may be adapted to determine a derivative value of a metric, and report the derivative value. The radio receiver according to this embodiment may be one of the radio devices 10-50 or one of the radio access nodes 120, 130. The radio transmitter may be the respective other entity, hence one of the radio access nodes 120, 130 or one of the radio devices 10-50. However, the radio transmitter may be the radio device 10-50 and the radio receiver may be the radio access node 120, 130, for instance for uplink beam tracking.

According to one embodiment there is provided a radio transmitter for communicating with a radio receiver in a wireless communication system. The radio transmitter may be adapted to receive a derivative value of a metric.

The radio receiver and/or transmitter according to this embodiment of the present invention may enable adequately performing synchronization in a system requiring frequent beam alignment or refinement. This may require determining a change of a metric with time, i.e. a temporal rate of change in a monitored signal condition metric.

In contrast to existing solutions where the radio access node may calculate the rate of change estimates based on received absolute quality metric reports, the direct reporting of the rate of change metrics may reduce latency inherent in deriving the derivative information from filtered metric values, thus improving the responsiveness of the beam adjustment procedure.

According to one embodiment of the present invention, a receiver may for instance measure, filter and report a temporal rate of change in a monitored signal condition metric, for example in addition to measuring, filtering and reporting the absolute measurements. This may improve the accuracy and responsiveness of beam tracking and refinement processes.

According to an embodiment of the present invention using the rate of change reports, the inaccuracies due to the legacy measurement reports may be avoided and the delay for the re-alignment of the transmission and reception beams may be reduced or minimized.

According to one embodiment of the present invention the radio receiver and/or the radio transmitter may be adapted to communicate using a directive beam, wherein the derivative value is used in controlling the directive beam. By that, beam tracking and refinement known in the prior art may be adapted in line with the at least one embodiment of the present invention in that the existing technology is enhanced through the usage of one or more new reports severing as a respective indicator for triggering channel tracking.

Such an indicator according to one embodiment of the present invention may be used to optimize the beamforming of selected beams, e.g. by means of preceding. Alternatively or additionally, this indicator may also be used to adjust beam tracking and refinement parameters if the beamforming cannot be adapted. Another use may be for optimized beam selection and handover processes.

According to one embodiment of the present invention the radio receiver may be a radio access node 120, 130 and the radio receiver may also be a wireless device capable of communicating with the radio access node 120, 130. Therefore, repetitive beam tracking and alignment processes may be avoided since synchronization loss may be proactively avoided.

One or mere of the embodiments described herein may be particularly suited for enhancing performance for Ultra-Reliable and Low Latency Communications, URLLC, applications such as in factory automation for rotating machines or applications regarding the internet of things, IoT, or machine-to-machine communication.

According to an embodiment of the present invention the derivative value may be reported to an entity different from the radio transmitter. For example, the derivative value may be reported to a radio access node not serving the reporting radio device or may be reported to an entity suitable for receiving and further processing or relaying the derivative value. In this case the radio access node not serving the reporting radio device or the entity receiving the report may relay or convey the report using a backhaul connection of the network system such as an internode connection. In LTE and NR the internode connection may be an X2 interface between the serving node and the receiving node.

According to an embodiment of the present invention determining the derivative value further may include measuring the respective metric.

According to another embodiment of the present invention the radio receiver may be adapted to receive instructions (e.g. from the radio access node to which the wireless device may report the derivative value) to perform determination of the derivative value, including timing and specification of the metric to be measured.

The receiver may perform pre-reporting filtering of the derivative itself that may for instance obviate the need for further Layer 3, L3, filtering in the network system.

According to one embodiment of the present invention, the radio receiver may be adapted to perform filtering of the metric value and/or the derivative value prior to the reporting of the derivative value. Such filtering may include Layer 1, L1 and/or Layer 3, L3 filtering.

Reporting of for instance L1 filtered derivative information at a given reporting rate to the network may provide a higher-fidelity picture of the channel changes than absolute measurements reported at the same rate.

In other words, reporting the derivative instead of letting the network derive it from quantized absolute quality values may also avoid the impact of quantization inherent in the report. In other words, the rate of change metric changes relatively slowly compared to the absolute quality metric and therefore may be filtered over a larger number of measurements to improve the report signal to noise ratio, SNR.

Note that in the following description, the terms reporting change, rate of change, and derivative may be used interchangeably.

According to another embodiment of the present invention the metric to be measured may indicate a signal quality and/or signal strength of a signal received at the receiver.

According to yet another embodiment of the present invention, the metric to be measured may be at least one of Received Signal Strength Indicator (RSSI), Received Signal Received Power (RSRP), Received Signal Received Quality (RSRQ), and Signal to Interference and Noise Ratio (SINR).

According to one embodiment of the present invention the reporting is periodic or triggered by a predetermined event.

Triggering the reporting by a predetermined event may present aperiodic reporting of the derivative value.

According to one embodiment of the present invention reporting further includes reporting of the measured metric.

According to one embodiment of the present invention controlling the directive beam may include controlling beam tracking, controlling beamforming configuration, and/or controlling beam refinement.

Beam tracking may relate to a reconfiguration of established beams for communicating between the radio access node and the wireless device where some minor changes are effected by the radio access node and/or the wireless device, but the established beam relations are maintained.

Beamforming configuration may relate to a set of established beams between the radio access node and the wireless device where the established beams may be switched for communication between the radio access node and the wireless device.

Beam refinement may relate to a configuration of established beams for communicating between the radio access node and the wireless device where the beam configuration is changed to increase the spatial resolution of the configuration, in other words narrowing the beam width according to the configuration.

Accordingly, the present invention may provide a more robust and more rapid responsive beam management solution, and thereby better link robustness and network resource utilization.

According to one embodiment of the present invention the radio receiver is adapted to employ Ultra-Reliable and Low Latency Communications, URLLC.

According to one embodiment of the present invention the radio receiver is a radio access node 120, 130 and the radio transmitter is a wireless device 10 capable of communicating with the radio access node 120, 130.

According to one embodiment of the present invention the radio transmitter may be further adapted to communicate using a directive beam, and control a directive beam based on the reported derivative value.

According to yet another embodiment of the present invention the radio transmitter may be further adapted to transmit instructions to the radio receiver to perform measuring the derivative value, including timing and specification of the metric to be measured.

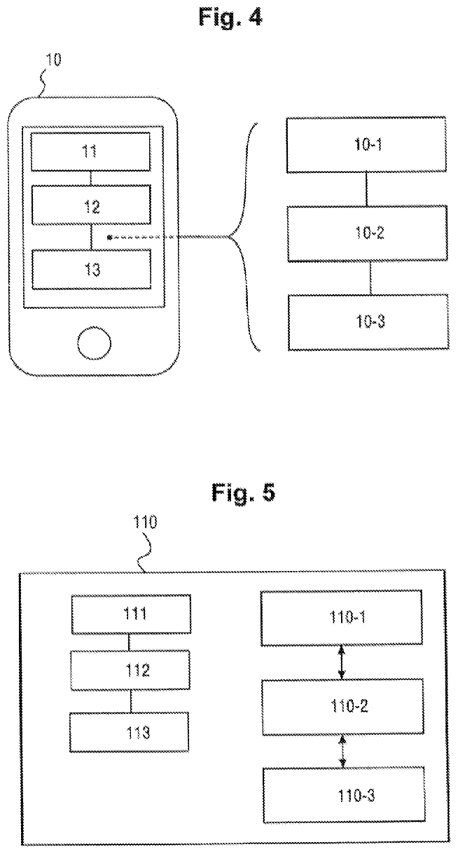

FIG. 4 shows a wireless device 10 adapted to perform a method according to the present disclosure. The radio device 10 may correspond to any of the radio devices 10-50 shown in FIG. 3.

The radio device 10 is adapted for connecting to a radio access system including at least a radio access node, for example one of the radio access nodes 120, 130, shown in FIG. 3, and optionally including one or more of the radio-devices 10-50. In a first embodiment shown on the right side of FIG. 4, the radio device 10 may include at least one processor 10-1, a memory 10-2, and a transceiver 10-3 with receiving and transmitting capabilities. The at least one processor 10-1 is coupled to the memory 10-2 and the transceiver 10-3. A computer program code comprising code is stored in the memory 10-2. The code is executable by the at least one processor 10-1. When the at least one processer executes the code, the wireless device 10 is caused to perform the above described steps.

In a second embodiment shown on the left side of FIG. 4, the radio device 10 includes an optional storage module 11, an optional processing module 12, and a communication module 13 for sending and/or receiving messages.

The processor 10-1 or processing nodule 12 may be adapted to determine a derivative value of a metric. Accordingly, the measured metric may be processed using Layer 1 and/or Layer 3 filtering through the processor 10-1 or processing module 12.

Further, the transceiver 10-3 or the communication module 13 may be adapted to report the derivative value for instance to the receiver or another network entity.

Further yet, the memory 10-2 or the storage module 11 may be adapted to store therein information with respect to the metric to be measured, the measured metric value, and the derivative information.

Generally, the above mentioned processing module 12 may be a processing unit, a processing unit collection, CPU, a share of a data/processing center and so on. The storage module 11 may be for example a memory. The communication module 13 may be embodied as a transceiver.

FIG. 5 shows a radio access node embodiment of the disclosure. The radio access node 110 may correspond to the radio access nodes 120, 130 described in FIG. 3. The radio access node 110 may be configured for a network system 100 including at least the radio access node 110 and a radio device, for example the radio device 10-50 of FIG. 3 or the radio device 10 of FIG. 3.

In particular, the radio access node 110 may be adapted to perform a method according to one embodiment of the present disclosure. Accordingly, according to one embodiment of the disclosure the radio access nods 110 comprises an optional memory module 111, an optional processing module 112, and a communication module 113.

In another embodiment according to the present disclosure the radio access node 110, i.e. radio access node 120, 130, may include at least an optional one processor 110-1, an optional memory 110-2, and a transceiver 110-3 with receiving and transmitting capabilities as illustrated on the right side of FIG. 5. The at least one processor 110-1 is coupled to the memory 110-2 and the transceiver 110-3.

The communication module 113 or transceiver 110-3 may be adapted to receive a derivative value of a metric. The communication module 113 or transceiver 110-3 may adapted to communicate using a directive beam.

The processing module 112 or the processor 110-1 may be adapted to control a directive beam based on the reported derivative value.

The communication module 113 or transceiver 110-3 may be adapted to transmit instructions to the radio receiver to perform measuring the derivative value, including timing and specification of the metric to be measured.

A computer program code comprising code is stored in the memory 110-2. The code is executable by the at least one processor 110-1. When the at least one processer executes the code, the rode 110 is caused to perform the above described steps.

Generally, the mentioned processing module 112 way be a processing unit, a processing unit collection, CPU, a share of a data/processing center and so on. However, the determining module 114 may be provided within the processing module 112 or may be connected to either one of the memory module 111, processing module 112, or communication module 113.

The memory module 111 may specifically store code instructing the processing module 112 during operation to implement any method embodiment of the present disclosure.

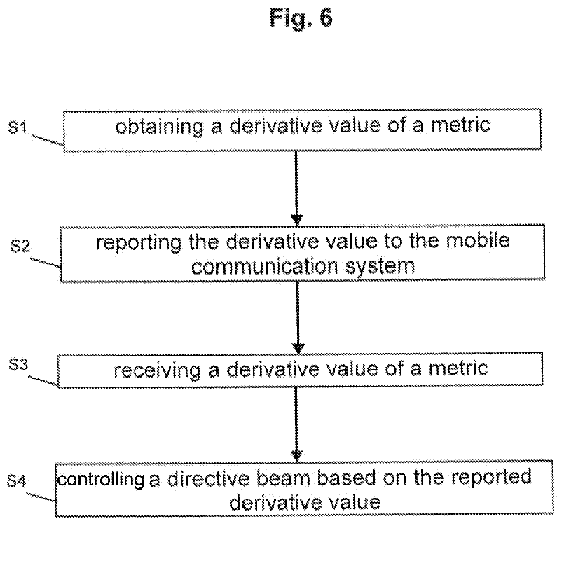

FIG. 6 shows a flowchart of a method embodiment of the present disclosure. The method may be applicable to a communication system comprising at least a radio receiver and a radio transmitter. The method may comprise a step S1 of determining a derivative value or a metric. In a next step 32 the derivative value is reported, e.g. to the communication system. In a further step S3, the derivative value of the metric is received. In a next step S4 a directive beam is controlled based on the reported derivative value. The first two steps S1 and S2 may be carried out by the node 120, 130 or the radio device 10-50. The last two steps may be carried out by the respective other one compared to the first two steps, hence the radio device 10-50 or the node 120, 130. In other words, both the radio access node 120, 130 and the wireless device 10-50 can act as a receiver or a transmitter in the communication system.

FIG. 9 shows a filtering unit 90 where derivative values may be filtered. There may be a filtering unit 91 for layer 1 filtering, a filtering unit 92 for layer 3 filtering, and an evaluation unit 93 for evaluating reporting criteria.

The filtering unit 90 may for instance receive further filter parameters, e.g. the filtering unit 92 may receive from another entity such as the serving radio access node 120, 130 filtering parameters.

Further, filtering unit 90 may for instance receive further beam tracking or beam refinement parameters for evaluating reporting criteria, e.g. the evaluation unit 93 may receive from another entity such as the serving radio access node 120, 130 beam tracking or beam refinement parameters. There may be provided an event trigger for triggering reporting of the derivative values.

The filtering unit 90 may be implemented by the radio receiver, e.g. the wireless device 10 or the radio access node 110, 120, 130. The filtering unit 90 can be part of the respective processing module 12, 112 or processor 10-1, 110-1, respectively, and optionally of the respective memory module 11, 111 or memory 10-2, 110-2, respectively.

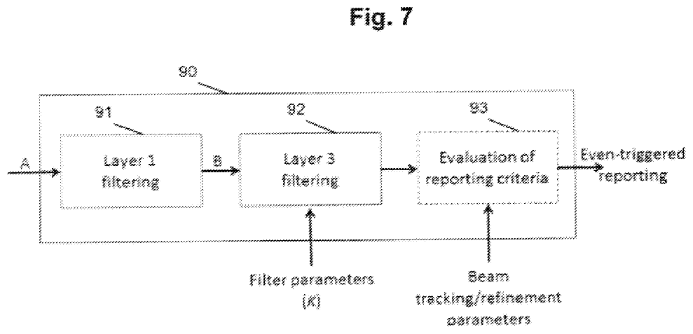

FIG. 7 shows a diagram in which the signal condition metric A is displayed in dependence on the time t. The underlying signal condition metric may be e.g. RSSI or RSRP. In this case, the unit of the underlying metric may be e.g., dB or dBm and the unit of the proposed rate of change metric may be e.g., dB/ms or dBm/ms, or per slot, or per another time unit. The underlying signal condition metric may alternatively be RSRQ or SINR, e.g. in units of dB, in which case the proposed rate of change metric would have units dB/ms, or per another time unit. The signal condition metric could also be a transformed metric e.g., Channel Quality Indicator, CQI. In this case, the unit of the proposed metric could be e.g., slot⁻¹, μs⁻¹, or ms⁻¹.

A measurement result for the proposed metric, e.g. from a Layer 1 point of view, may be expressed as follows

$${M}_{n} = \vert \frac{dA}{dt} \vert = \vert \frac{Δ A}{Δ t} \vert = \vert \frac{{A}_{2} - {A}_{1}}{{t}_{2} - {t}_{1}} \vert$$

where Layer 1 measurements, A₁ and A₂, of two consecutive time instants, t₁ and t₂, may be used to form the proposed temporal change metric Mₙ. “Δₜ denotes the temporal charge period.

For example, in L1 a received signal strength is measured. This may be called a L1 measure or the metric. The measured value may represent the result of the measurement of the signal in a radio device 10 for a fraction of time such as a subframe or slot duration. Using more than one L1 measurement a new metric may be determined such as a derivative metric. The derivative metric may be formed in L1 or L3 depending on where computation or processing of the measures absolute metric value is carried out.

In addition to L1 filtering, L3 filtering can be optionally performed to remove further effects for instance due to measurement errors in L1 or due to larger time scale fluctuations in the signal. If the derivative metric is formed at L1, then L3 filtering may be applied in addition. In fact, L3 filtering can be applied even if the metric is formed at L3, since L3 filtering in the simplest sense just relates to averaging a series of values belonging to the same metric or measure.

Layer 1 filtering might not be standardized as in LTE and the measurement interval, e.g. the interval to measure “A”, is for instance specified by a third party such as a chipset manufacturer.

The measurement may be performed for the complete system bandwidth to neglect the measurement errors and to meet the standard requirements of measurement accuracy. Alternatively, the measured bandwidth may be limited.

The temporal change period Δₜ may be specified in the standard, and, if more than one value is allowed, this value may be configured for instance by the network.

In another embodiment, Layer 3 filtering may be performed according to a standard, e.g. Technical Specification (TS) 36.331 V14.4.0 (2017-09) in LTE. In this case, the existing Layer 3 filtering may be considered as suitable and may be reused for the new channel tracking metric

Fₙ=(1−a)·Fₙ₋₁+a·Mₙ

where “Mₙ” denotes the latest received measurement result for the metric from the physical layer e.g as defined above. “Fₙ” denotes the updated filtered measurement result for the metric, that may be used for evaluation of a reporting criteria for measurement reporting. “Fₙ₋₁” denotes the “old” filtered measurement result for the metric, wherein “F₀” may be set to “M₁” when the first measurement result of the metric from the physical layer is received. a is equal to 1/2^{(k/4)}, where k denotes the filter coefficient for the corresponding measurement quantity received.

For instance, received signal strength, RSSI or preferably RSRP, in L1 is measured. This represents the L1 RSSI or RSRP measure. For instance by using two consecutive L1 RSSI measure values an L1 derivative metric value is determined. L3 filtering may be carried out on top of these L1 RSSI measure values and determined L1 derivative metric values. Both L3-filtered RSSI measure value and L3-filtered derivative metric value may be reported.

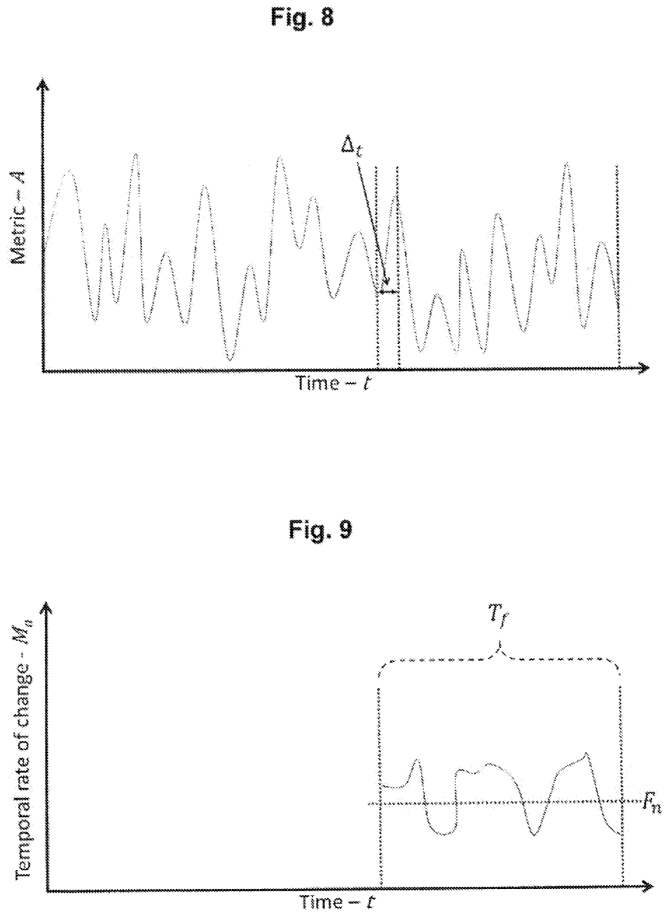

In another embodiment of L3 filtering, linear averaging is used for Layer 3 filtering if L3 filtering is not specified in a standard and therefore implementation related, or a new filtering mechanism can be used for future systems such NR. Such a L3 filtering baaed on averaging can be defined by

$${F}_{n} = \vert \frac{{\sum }_{i}^{n} \frac{{A}_{i} - {A}_{i - 1}}{{t}_{i} - {t}_{i - 1}}}{n} \vert$$

wherein “i” spans the filtering period, which is referred as “T_{f}” in FIG. 9 or in other words “i” is a sample counting index describing layer 3 filtering. FIG. 9 slows a graph for derivative information determined from the metric shown in FIG. 8.

In some embodiments, depending on node assignments and link direction, i.e., uplink of downlink, the beam refinement needs to take place, the filtered measurement for the proposed metric may be reported to another node 110. For instance when the radio device measures candidate beams from multiple cells or radio access nodes but may report all results to its serving radio access node. In this respect, downlink denotes the direction from the radio access node 120, 130 to the wireless device 10-50, and uplink denotes the direction from the wireless device 10-50 to the radio access node 120, 130.

The reporting may be based on at least one of the following: In one option, the reporting is performed periodically, i.e. the measurement may be sent on a regular basis following a certain pattern or periodicity that may be identified by a parameter. In some embodiments, the parameter is configurable by the node 120, 130 that is reported to. In a second option, the reporting can be event-driven, i.e. the measurement report may be triggered once when the filtered value “Fₙ” is above or below a threshold, e.g., during a time-to-trigger interval This interval can be, in some embodiments, configurable by the node 120, 130 that is reported to. In a third option, the reporting is triggered by a radio link problem/failure, e.g. a Radio Link Failure (RLF) as know from LTE. In such an option, measurements may be reported once that a radio link problem/failure is experienced. It is noted that the radio link failure may represent a specific event in the sense of the second option. The reporting according to the second and third option can be considered as aperiodic reporting.

As explained above, the derivative information may be a complement to the traditional, absolute quality information, instead of replacing it. In principle, “dead reckoning” based on the change information can be used to track the absolute quality values for a limited time, but after a while the estimate diverges due to accumulated reporting errors. Therefore, such embodiments may include derivative reporting at a certain rate and absolute reporting at a lower rate to recalibrate periodically.

In another embodiment, event-triggered reporting as described above may be employed, based on detected rapid rate of change being excellent. Such reporting may be further subject to a minimum absolute quality threshold.

In an embodiment, the network may configure the wireless device 10-50 for which beams the signal condition should be reported e.g., for the serving beam, one or more of the serving radio access node's beams, or other beams whose measured metric is above or below a certain threshold.

The option of monitoring the serving TX beam and a set of “surrounding” beams, e.g. in a 2D grid sense, may be a particularly advantageous configuration. Reporting the derivative, e.g. for just the serving beam and the most rapidly growing beam that may be subject to some minimum absolute quality criterion, may represent an efficient way to ensure a robust beam switch with reduced ping-pong probability.

In case continuous serving beam adjustment instead of beam switching is applied, information about monitored beams may be equally useful and the rate of change values may also help to determine how fast to realign the serving beam. In other words, from the rate of change it may be determined how fast beam tracking or beam adjustment needs to be performed.

While the derivative values may be more amenable to filtering, estimates of derivatives or in general differentials may be inherently noisier, e.g. by 3 dB, due to the fact that these derivative values are affected by noise from two absolute measurements. In one embodiment, the radio device 10 may apply an additional criterion for the derivative reporting, namely that the measured SINR, RSRP, RSRQ, etc. of the absolute quality metric for a given beam, or of a filtered metric used to determine the derivative, may have to be sufficiently high, in order to avoid reporting noise fluctuations on weak beams.

In one embodiment, if the beam refinement is to take place, the proposed report or reports of the derivative value, each serving as a respective channel tracking indicator may be used for deciding the beamforming configuration and/or preceding, e.g., how directive the beam may be, i.e. narrow or wide. These reports are sent by following one of the aforementioned reporting options to radio receiver or any other decision-making entity which may receive the derivative values from the radio transmitter or an in-between entity, in other words in case the beam is not controlled by the receiving entity, if it is not already available on that end.

In another embodiment, the radio device 10 may report the temporal downlink signal condition change to the radio access node 120, 130 and, eventually, trigger the beam refinement procedure.

In some embodiments, the network may hand the radio terminal over to a beam that is of lower signal condition change, i.e. imbalance, even though it may for instance not be the best beam in terms of legacy absolute RSRP or RSRQ measurements.

In some embodiments, the proposed measurement indicating the temporal rate of change may be reported together with the absolute measurements, e.g., when the reporting of absolute measurements is triggered. In this case, the temporal rate of change may be taken into account by the radio access node 120, 130 for the beam selection/handover or refining the beam.

In some embodiments, in addition to or instead of narrowing or widening the beam or handing the radio device 10 over to a different beam, there may be other actions that may be taken. Examples of such actions include increase or decrease the beam tracking speed and/or periodicity, increase or decrease the beam beaconing periodicity, increase or decrease of measurement related configurations such as the temporal change period, increase or decrease of the beam selection offset and/or any other relevant beam selection parameters.

In some embodiments, the described concepts according to the present disclosure may be selectively used for enhancing performance for URLLC applications such as in factory automation for the rotating machines. Thus, the measurement can also be configured only for those radio devices 10-50 or nodes 120, 130 e.g., based on their categories and/or Quality of Service (QoS) classes and/or slice configurations.

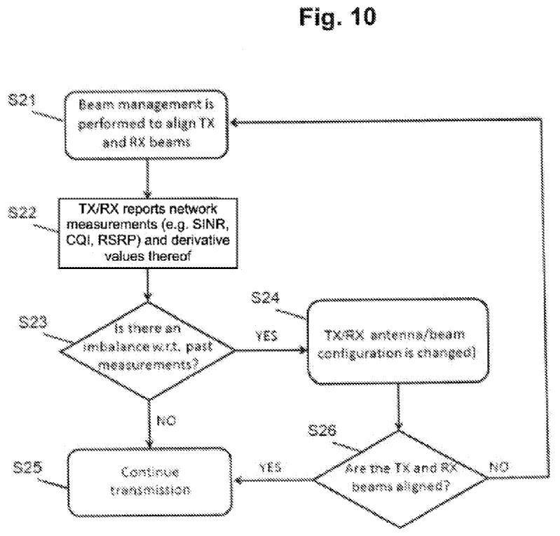

FIG. 10 shows a flow chart of a method according to an embodiment of the present invention. In a first step S21 beam management is performed to align transmitter and receiver beams. In a further step S22 the transmitter and/or receiver report network measurements such as SINR, CQI, and/or RSRP, in addition to the reported derivative values of one or more of those metrics. The transmitter may for instance also report the network measurements to another entity in the network system. In a next step S23 it is determined, whether there is an imbalance or unexpected change with respect to past measurements.

In case there is an imbalance determined in step S23, a step S24 is performed for changing transmitter and/or receiver antenna and/or beam configuration. In a next step S26 it is determined whether the transmitter and receiver beams are aliened. In case the determination in step S26 is not in the affirmative, the process returns to step S23. In case it is determined that the beams are aligned, the process continues with stop S25 for continuing transmission.

In case there is no imbalance determined in step S23, the process continues directly with step S25 for continuing transmission.

Although detailed embodiments have been described, these only serve to provide a better understanding of the disclosure defined by the independent claims and are not to be seen as limiting.

1. A radio receiver for communicating with a radio transmitter in a wireless communication system, the radio receiver adapted to
determine a derivative value of a metric; and
report the derivative value.

2. The radio receiver according to claim 1, wherein the radio receiver and/or the radio transmitter is adapted to communicate using a directive beam, wherein the derivative value is used in controlling the directive beam.

3. The radio receiver according to claim 1, wherein the radio transmitter is a radio access node and the radio receiver is a wireless device capable of communicating with the radio access node.

4. The radio receiver according to claim 1, wherein the derivative value is reported to the radio transmitter or is reported to an entity different from the radio transmitter.

5. The radio receiver according to claim 1, wherein determining the derivative value further includes measuring the respective metric.

6. The radio receiver according to claim 1, wherein the radio receiver is adapted to receive instructions to perform determination of the derivative value, including timing and specification of the metric to be measured.

7. The radio receiver according to claim 1, wherein the radio receiver is adapted to perform filtering of the metric value and/or the derivative value prior to the reporting of the derivative value.

8. The radio receiver according to claim 1, wherein the metric to be measured indicates a signal quality and/or signal strength of a signal received at the receiver.

9. The radio receiver according to claim 1, wherein the metric to be measured is at least one of Received Signal Strength Indicator (RSSI), Received Signal Received Power (RSRP), Received Signal Received Quality (RSRQ), and Signal to Interference and Noise Ratio (SINR).

10. The radio receiver according to claim 1, wherein the reporting is periodic or triggered by a predetermined event.

11. The radio receiver according to claim 5, wherein reporting further includes reporting of the measured metric.

12. The radio receiver according to claim 1, wherein controlling the directive beam includes controlling beam tracking, controlling beamforming configuration, and/or controlling beam refinement.

13. The radio receiver according to claim 1, wherein the radio receiver is adapted to be employed in Ultra-Reliable and Low Latency Communications.

14. A radio transmitter for communicating with a radio receiver in a wireless communication system, the radio transmitter adapted to
receive a derivative value of a metric.

15. The radio transmitter according to claim 14, wherein the radio transmitter is further adapted to
communicate using a directive beam, and
control a directive beam based on the reported derivative value.

16. The radio transmitter according to claims 14, wherein the radio transmitter is further adapted to
transmit instructions to the radio receiver to perform measuring the derivative value, including timing and specification of the metric to be measured.

17. A communication system comprising the radio receiver according to claim 1 and a radio transmitter adapted to receive the derivative value of the metric.

18. A method, in a radio receiver, for communicating with a radio transmitter in a wireless communication system, comprising the steps of
determining a derivative value of a metric; and
reporting the derivative value.

19. A method, in a radio transmitter, for communicating with a radio receiver, comprising the steps of
receiving a derivative value of a metric.

20. A method in a communication system comprising at least a radio receiver and a radio transmitter, the method comprising the steps of
determining a derivative value of a metric;
reporting the derivative value; and
receiving a derivative value of a metric.

21. A computer program comprising code, wherein the code, when executed on processing resources, instructs said processing resources to perform a method according to claim 18.

22. A computer program product storing code, wherein the code, when executed on processing resources, instructs said processing resources to perform a method according to claim 18.
